(19) United States
(12) Patent Application Publication
(10) Pub. No.: US 2026/0311092 A1
(43) Pub. Date: Oct. 8, 2026

(54) DISTRIBUTED COMPUTER SYSTEM FOR MANAGEMENT OF SERVICE REQUEST AND METHOD OF OPERATION THEREOF

(71) Applicant: UVUE LTD., Bury St Edmunds (GB)

(72) Inventor: Humayun Munir Sheikh, Bury St Edmunds (GB)

(21) Appl. No.: 19/709,332

(22) Filed: Jun. 16, 2026

Related U.S. Application Data
(63) Continuation of application No. 17/234,932, filed on Apr. 20, 2021.

(51) Int. Cl. G06Q 10/0631

(52) U.S. Cl. CPC G06Q 10/06316

(57) ABSTRACT

There is disclosed a distributed computing system using one or more autonomous economic agents for managing services, for example technical services or technical functionality. The system includes a client economic agent that generates and broadcasts a service request. The system further includes a plurality of service providers that generate a service bid and communicate the service bid to the client autonomous economic agent. Moreover, the system includes an open economic framework, implemented on a distributed computing network, that selects a service provider autonomous economic agent for providing the service, from the plurality of service provider autonomous economic agents which are configured to execute the service.

### TECHNICAL FIELD

The present disclosure relates to systems and methods for (of) operating the systems, wherein the methods for (of) operating the systems involve controlling their technical features to provide services, and managing the services using one or more autonomous economic agents via an open economic framework (OEF) implemented on a decentralized computing network. Moreover, the methods are relevant, for example, to service industries employ the open economic framework (OEF), wherein the services include, for example, technical resources, technical materials, technical components, and similar; beneficially, the methods include modifying adaptively a technical operation of the decentralized computing network in response to operations being executed in the open economic framework (OEF) to increase its robustness to hostile third-party attacks, by adaptive and selective use of data encryption, data obfuscation, and temporal data decoys. The present disclosure is concerned with a technical manner of operation of the decentralized computing network and how data is processed with the network, to make the decentralized computing network more robust to third-party hostile attack.

### BACKGROUND

Technological innovations have enabled human life to be implemented at an increasingly faster pace. Furthermore, there is now arising an increasing reliance on advanced technologies, such as virtual assistants, artificially intelligent robots and so forth, for many peoples' daily activities. For example, daily activities like cleaning, cooking and communicating may be implemented or executed using such technologies. Moreover, with a recently growing spectrum of services available using aforesaid technologies, there arises a need for managing service providers that may be used to procure services to perform such activities.

Conventionally, when a given user wants to procure such services:
(a) the user is firstly required to find service providers that are capable of providing the services required; and
(b) secondly, only a limited number of service providers may be available in the given user's location, providing services that are within the given user's budget, in the given user's required time frame, and so forth. In such a situation, the given user is required to compare available service providers in terms of locations of their operations, their costs, their availabilities, their reliabilities and so forth.

It will be appreciated that such a practice is associated with various drawbacks, namely involving technical problems, that are addressable in a technical manner, for example by invoking use of certain types of specialist data communication networks. Therefore, presently, finding a service provider for acquiring services may potentially be complex, inconvenient and time-consuming for the given user.

Furthermore, the user may employ services or technical functionalities of an intermediary to overcome the aforementioned drawbacks, namely technical problems. In such an example, the intermediary may assist the given user to select an optimal service provider. However, the given user may employ or utilize a service provider suggested by the intermediary, without verifying a reliability of the service provider. Moreover, one or more service providers may have provided inaccurate details thereof, and potentially paid a bribe or financial inducement, to enable the service provider to acquire more users. In such an example, the user does not possess a reliable independent framework to check an accuracy of the information furnished by the service providers, to ensure that a highest quality of service is provided for example. Additionally, in a case of an unsuccessful service provided by the service provider, the user may incur a loss of payment given to the intermediary and the hired service provider.

Networks that enable services to be ordered and services to be delivered become relied upon, such that technical disruption of the networks potentially has considerable economic and societal impact. Thus, a robustness of network supporting such order and delivery of services is a primary technical concern. Moreover, critical points of failure of the networks is also a technical concern, because malicious third parties trying to disrupt operation of the networks will try to exploit weak point (“critical point of failure”) of the networks, or portions of the networks that convey particularly large amounts of consideration. Whereas, a given network can be made robust through the use of encryption, for example public-private key encryption, the use of heavy degrees of encryption through a network support ordering and supply of services potentially renders the given network unwieldy and inefficient in operation, especially when the given network is being progressively evolve over time as new service ordering techniques and new service delivery arrangements are implemented via the given network.

Therefore, in light of the foregoing technical problems and related system operation issues, there exists a need to address the aforementioned problems associated with operating systems to provide various types of services to users.

### SUMMARY

The present disclosure seeks to provide an improved system for using one or more autonomous economic agents to manage services, for example to manage technical services.

The present disclosure also seeks to provide an improved method for (of) using one or more autonomous economic agents to manage services, for example to manage technical services.

According to a first aspect, an embodiment of the present disclosure provides a system that uses in operation one or more autonomous economic agents for managing services, wherein the services include technical services, characterised in that the system includes:
a client autonomous economic agent that, when in operation, generates and broadcasts a service request, wherein the client autonomous economic agent receives instructions to generate the service request from a given user;
a plurality of service provider autonomous economic agents, wherein each of the plurality of service provider autonomous economic agents is associated with at least one service component, and wherein each of the plurality of service provider autonomous economic agents when in operation:
receives the service request from the client autonomous economic agent,
generates a service bid, in response to the service request, and
communicates the service bid to the client autonomous economic agent;
an open economic framework (OEF), implemented on a decentralised computing network, that is communicably coupled to the client autonomous economic agent and the plurality of service provider autonomous economic agents, wherein the open economic framework includes an open economic ledger that stores when in operation a confidence score of each of the plurality of service provider autonomous economic agents, characterised in that the open economic framework (OEF) when in operation:
selects a service provider autonomous economic agent for providing the service, from the plurality of service provider autonomous economic agents, based upon at least one of: confidence scores of the plurality of service provider autonomous economic agents, service bids provided by plurality of service provider autonomous economic agents; and
provides the service to the client using the service provider autonomous economic agent selected for providing the service.

The system is of advantage in that creating a data communication network to implement the open economic forum (OEF) provides for more efficient functioning of the system when providing the service to the client.

Optionally, in the system, the decentralized computing network is implemented with a degree of data protection that employs adaptive data encryption and data obfuscation processing operations depending upon one or more parameters of a service recorded on the open economic ledger.

Optionally, in the system, when the decentralized computing network is in operation, the adaptive data encryption and data obfuscation processing operations are selected depending upon at least one of: a temporal rate of execution of services via a given node of the decentralized computing network, considerations associated with services being executed via a given node of the decentralized computing network.

Optionally, in the system, the adaptive data encryption and data obfuscation processing operations employ a combination of following data protection processes: encryption, decryption, data obfuscation by swapping one or more bits of data bytes, addition of obfuscating redundant data (“data decoys”), temporally randomized transmission times for data within the decentralized computing network.

Optionally, at least one of the service bids provided by the plurality of service provider autonomous economic agents is a collective bid provided by multiple service provider autonomous economic agents, wherein the multiple service provider autonomous economic agents collectively provide the service to the client.

Optionally, one of the multiple service provider autonomous economic agents operates as a secondary client autonomous economic agent, wherein the secondary client autonomous economic agent executes when in operation a first portion of service, and wherein the secondary client autonomous economic agent when in operation:
generates a secondary service request for executing a remaining portion of the service;
receives service bids from a second plurality of service provider autonomous economic agents, for executing at least a segment/part of the remaining portion of the service;
determines, from the second plurality of service provider autonomous economic agents, one or more service provider autonomous economic agents to collaborate with a secondary client autonomous economic agent to form multiple service provider autonomous economic agents collectively providing the service.

Optionally, the one or more service components are associated with a drone.

Optionally, the one or more service components include at least one of: a drone frame; a camera module; a mission planning module; a sensor module; a communication module.

Optionally, the confidence score includes at least one of:
historical information of services provided using the service provider autonomous economic agent;
number of services provided using the service provider autonomous economic agent.

Optionally, the service request includes at least one of: a time needed for providing the service; a price associated with the service; a quality associated with the service; at least one preference associated with the service.

Optionally, each of the client autonomous economic agent and the service provider autonomous economic agents is connected to a data processing arrangement.

Optionally, the selected service provider autonomous economic agent is remunerated by a digital token for the provided service.

Optionally, the open economic ledger is implemented using a distributed ledger.

According to a second aspect, an embodiment of the present disclosure provides a method for (of) managing services using one or more autonomous economic agents characterised in that the method includes:
(i) generating and broadcasting a service request using a client autonomous economic agent;
(ii) using a plurality of service provider autonomous economic agents, wherein each of the plurality of service provider autonomous economic agents is associated with at least one service component, wherein each of the plurality of service provider autonomous economic agents when in operation:
receives the service request from the client autonomous economic agent,
generates a service bid, in response to the service request, and
communicates the service bid to the client autonomous economic agent;
(iii) implementing an open economic framework on a decentralised computing network that is communicably coupled to the client autonomous economic agent and the plurality of service provider autonomous economic agents, wherein the open economic framework includes an open economic ledger for storing a confidence score of each of the plurality of service provider autonomous economic agents, wherein the open economic framework when in operation:
selects a service provider autonomous economic agent for providing the service, from the plurality of service provider autonomous economic agents, based upon at least one of: confidence scores of the plurality of service provider autonomous economic agents, service bids provided by plurality of service provider autonomous economic agents; and
provides the service to the client using the service provider autonomous economic agent selected for providing the service.

The present disclosure seeks to provide the method and system that use one or more autonomous economic agents to manage services, for example technical services; the method and system enable the service provider autonomous economic agent to be selected for providing the service, based upon at least one of: confidence scores of the plurality of service provider autonomous economic agents, service bids provided by plurality of service provider autonomous economic agents. Such selection of the service provider autonomous economic agent enables services to be acquired from trustworthy and reliable service providers, thereby, saving time, money and effort for a given user.

Optionally, the method includes implementing the decentralized computing network with a degree of data protection that employs adaptive data encryption and data obfuscation processing operations depending upon one or more parameters of a given service recorded on the open economic ledger.

More optionally, when using the method, the decentralized computing network is in operation, the adaptive data encryption and data obfuscation processing operations are selected depending upon at least one of: a temporal rate of execution of services via a given node of the decentralized computing network, considerations associated with services being executed via a given node of the decentralized computing network.

Yet more optionally, when using the method, the adaptive data encryption and data obfuscation processing operations employ a combination of following data protection processes: encryption, decryption, data obfuscation by swapping one or more bits of data bytes, addition of obfuscating redundant data (“data decoys”), temporally randomized transmission times for data within the decentralized computing network.

Optionally, the system and the method for providing a service using one or more autonomous economic agents may be implemented with a single autonomous economic agent service provider.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system for using one or more autonomous economic agents to manage services, for example technical services, in accordance with an embodiment of the present disclosure;

FIG. 2 is a schematic illustration of service components of FIG. 1 associated with a drone, for example for providing a technical surveillance service, in accordance with an embodiment of the present disclosure;

FIGS. 3A and 3B is an illustration of steps of a method of using one or more autonomous economic agents for managing services, in accordance with an embodiment of the present disclosure; and

FIG. 4 is an illustration of a process that occurs in the system of FIG. 1.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In overview, embodiments of the present disclosure are concerned with systems using one or more autonomous economic agents for managing services, for example technical services. Furthermore, embodiments of the present disclosure are concerned with methods for using one or more autonomous economic agents for managing services, for example technical services.

The term “service” as used herein refers to an arrangement (namely, “means for”) performing an action (namely, an activity) and/or providing assistance for performing such an action. For example, the “service” optionally relates to an action of machining or cutting a given component or element, or dying a given component or element, or sewing a given component or element, or washing a given component or element, or communicating a given component or element via a wired or wireless network, and so forth. The term “managing services” as used herein refers to managing a service as requested by a user that includes a plurality of service steps/segments; the service can include, for example, instructing tasks to be implemented using robotic devices, including for affecting machine control. Embodiments of the present invention provide for automatic management of a service process which includes generation of a service request, broadcasting of the service request, generation of service bids in response to the service request, selecting one or more service providers and providing the service to the client, where in the selection of one or more service providers involves an autonomous decision made by the autonomous economic agent (or agents) managing the service process

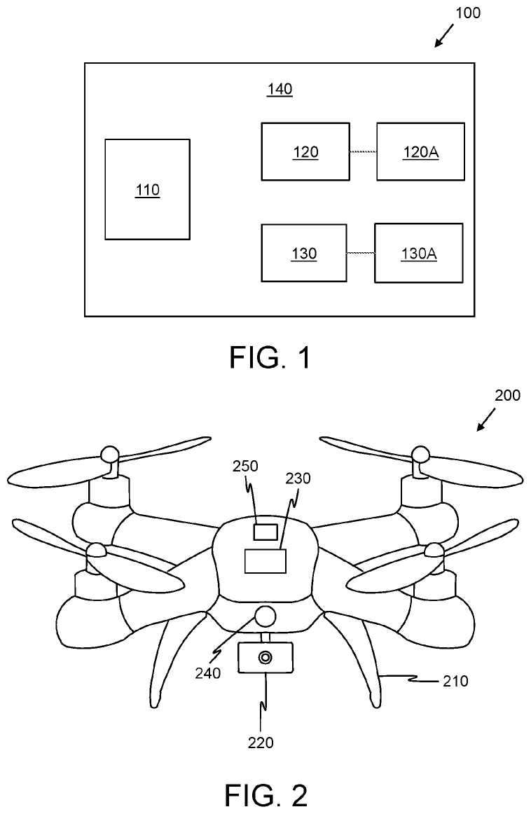

Referring to FIG. 1, there is shown a block diagram of a system 100 that, when in operation, uses one or more autonomous economic agents for receiving service requests, requesting services, providing services or managing services; such serves, for example, include technical services, for example in accordance with an embodiment of the present disclosure. The term “autonomous economic agents” (referred to hereinafter as “AEAs”) as used herein, relates to software modules that, autonomously, execute one or more technical tasks. For example, the one or more technical tasks optionally include wired or wireless communication of the AEAs with each other, processing of information and so forth. In an example, the AEAs employ, when in operation, artificial intelligence (AI) algorithms (namely self-adjusting adaptive algorithms) and machine learning to execute the one or more tasks. In another example, the AEAs are associated with a digital environment (referred to herein later as “Open Economic Framework” or “OEF”). The OEF is a computing framework, implemented via use of a decentralized computing network, that enables execution of tasks associated with various AEAs within the OEF. Furthermore, the OEF provides various tools, security protocols, rules and suchlike for the execution of tasks including, but not limited to, communication, processing of information and so forth, between different AEAs associated with the OEF. For example, the OEF allows, when in operation, access to one or more AEAs to operate within the OEF based on a set of rules and/or security protocols. Similarly, the OEF may deny access to one or more AEAs to operate within the OEF upon determining that the AEAs do not comply with the set of rules and/or security protocols. In one example, the OEF is implemented by one or more AEAs that are configured to enable communication between other AEAs within the OEF, process information associated with interaction between other AEAs within the OEF, provide (or deny) access to one or more AEAs to the OEF and so forth. Moreover, the OEF enables a decentralized economic market to be provided for enabling various services to be provided and/or procured by the AEAs. Such a decentralized economic framework, for example a decentralised market, may be representative of a real-world environment, such as a real-world market, wherein one or more services are provided and/or procured. The decentralized computing network is beneficially adaptive in its hardware operation in response to a type of task being processed therethrough. For example, the decentralized computing network beneficially adaptively employs a degree of data encryption and/or data obfuscation that is made progressively more secure as a financial value or strategic significance of a given being processed through the system increases. Such an approach to enhancing reliability of operation of decentralized computing network is adopted in order to provide robustness against third-party malicious attacks, while not rendering the system 100 unworkable because an inappropriately high degree of encryption and data protection being employed within the system 100.

The system 100 includes a client autonomous economic agent 110 for generating a service request, wherein the client autonomous economic agent 110 is communicably coupled to a client device (not shown). For example, the client device is associated with a user that wants to obtain a service using the system 100. In such an example, the user uses the client device to input details of his/her service requirements, which may include, for example, a type of service, a time constraint if any; a price associated with the service; a quality associated with the service; at least one preference associated with the service. Furthermore, the service requirement details that are provided by the user using the client device are communicated to the client AEA 110 associated with the client device. Based on the input details, the client AEA 110 when in operation generates and broadcasts a service request corresponding to the service required by the user. The term “broadcast a service request”, as used herein, relates to communicating of the service request to a plurality of AEAs within the OEF.

In one example, each user of the system 100 is provided with an individual client AEA 110. Such a client AEA 110 is configured, namely operable, to provide the user with a maximum value when using the system 100 to obtain a service. For example, such a value is associated with an economic value associated with the service (such as, for enabling the user to obtain a most economical service), a time associated with the service (such as, enabling the user to obtain fastest service), a quality associated with the service (such as, enabling the user to obtain a highest quality of service) and/or a combination thereof. In one example embodiment, the client device includes a portable communication device. For example, the client device is at least one of a smartphone, a laptop computer, a tablet computer and so forth. In such an example, the service requirement details may be provided by the user by using a graphical user interface (GUI) provided on the client device.

The service request is generated autonomously and automatically by the client AEA 110. For example, the service request is generated using the client AEA 110 associated with the client device. Such an automatic generation of the service request using the client AEA 110 may be based on obtaining the maximum value for the user, a schedule that is pre-defined by the user and so forth; optionally, artificial intelligence (AI) algorithms are employed to generate the service request. In one example, the client device includes an electrical vehicle and the service request includes an autonomous request by the electrical vehicle for charging an electrical battery of the electrical vehicle; the artificial intelligence, based upon data provided from a remote database, a charging regime that is suitable for the electrical battery, for example for obtaining greatest battery service life longevity or most prompt battery recharging. In such an example, a client AEA 110 associated with the electrical vehicle is configured, namely is operable, to determine a price associated with charging the electrical battery. Furthermore, the client AEA 110 is configured, namely operable, to generate the service request to initiate charging of the electrical battery upon determination of minimum price associated with charging the electrical battery, thereby, providing the maximum economic value to the user. In another example, the client AEA 110 is configured, namely operable, to generate the service request at a specific time during a day based on a charging schedule that is pre-defined by the user of the electrical vehicle. A selection of an optimal recharging regime for a given type of electrical vehicle battery is the subject matter of many granted patents for battery chargers, for example.

In an embodiment, the service request includes at least one of a time needed for providing the service, a price associated with the service, a quality associated with the service, and/or at least one preference associated with the service. For example, the user specifies a parameter (such as, using the graphical user interface associated with the client device) including at least one of the time, the price, the quality and/or at least one preference that is required by the user in the provided service. In such an example, the parameter is provided to the client AEA 110. Furthermore, the client AEA 110 is configured, namely operable, to generate the service request and to use the parameter to provide the maximum value to the user. In one example, the service request includes the price associated with the service, such as a minimum and maximum price associated with the service. In such an example, the client AEA 110 enables the user to obtain the service at a price within the minimum and maximum prices specified by the user. Preferably, the client AEA 110 enables the user to obtain the service associated with the minimum price, thereby, enabling maximum value to be provided to the user. In another example, the service request includes a preference associated with the service, such as, to obtain an eco-friendly service. In such an instance, the client AEA 110 enables the user to obtain the service from a service provider that utilizes eco-friendly sources of energy (and/or materials) for providing the service. It will be appreciated that embodiments of the present disclosure are not limited just to financial considerations, but various technical considerations are beneficially taken into account for saving energy utilization, avoiding excess stress to component parts, providing enhanced operating longevity and so forth. These are all technical effects.

The system 100 includes a plurality of service provider autonomous economic agent (referred to herein later as “service provider AEA”) 120, 130, wherein each of the plurality of service provider AEA is associated with at least one service component. Each of the plurality of service provider AEA, such as service provider AEA 120, 130, is configured, namely operable, to receive the service request from the client autonomous economic agent. Moreover, each of the service provider AEA, such as service provider AEA 120, 130, is configured, namely operable, to generate a service bid, in response to the service request. The service bid may include details pertaining to tentative delivery timeline, pricing details, as well as various technical parameters such as energy storage, energy conservation, utilization of materials, carbon emission footprint and so forth. Furthermore, each of the service provider AEA such as service provider AEA 120, 130 is configured, namely operable, to communicate the service bid to the client autonomous economic agent 110. However, it will be appreciated that the service provider AEAs 120, 130, and the client AEA 110 are operable to perform interchangeable functions, namely the service provider may simultaneously be a client AEA 110 that may be acquiring services from one or more other service provider AEA, such as service provider AEA 120, 130. Similarly, the client AEA 110 may be service provider AEA 120, 130 providing services to one or more other client AEAs 110. The term “service component” as used herein, relates to an arrangement that is independently (autonomously) capable of providing a service which may include at least one decision making and at least one action associated with the provision of the service; beneficially, artificial algorithms are employed when delivering such services. Furthermore, such an arrangement may include one or more hardware devices and/or one or more software modules (other than AEAs). In one example, the service components are associated with spatially separated hardware modules, wherein each of the spatially separated hardware modules is associated with a service provider AEA, such as service provider AEA 120, 130. In such an instance, the two service components 120A, 130A include two taxis (such as, autonomous cars (namely, autonomous vehicles)) associated with two different service providers, such as service provider AEA 120, 130. Furthermore, when the generated service request includes a request by a user to journey from a current location thereof to another location, the service provider AEAs, such as service provider AEA 120, 130, associated with the two taxis are configured, namely operable, to generate service bids. It will be appreciated that the service bids generated using a plurality of service provider AEAs, such as service provider AEA 120, 130, may be different from one another, namely the service bids may be mutually different. For example, a price and/or time quoted using the service provider AEAs, such as service provider AEA 120, 130, for the journey are different from each other. Furthermore, the service provider AEAs, such as service provider AEA 120, 130, provide a maximum value to service providers associated with the two service components 120A, 130A. For example, the service provider AEAs, such as service provider AEA 120, 130, are configured, namely operable, to generate the service bids for the journey that is associated with highest price for service, a shortest journey and so forth, thereby, enabling to provide maximum economic value to the service providers associated with the service components 120A, 130A.

In one embodiment, the service provider autonomous economic agents, such as service provider AEA 120, 130, enable an optimisation, for example a maximisation of a utilization of service components 120A, 130A. For example, when the two service components 120A, 130A are associated with charging terminals capable of charging electrical batteries of electrical vehicles, the service provider AEAs such as service provider AEA 120, 130, are configured, namely operable, to generate the service bids to occupy an empty time slot for providing the service when the charging terminals are not required to be in operation; for example, the time slots may be selected depending upon electrical power grid loading predictions and/or generating capacity predictions, that temporally varying depending upon an operating status of the electrical power grid. It will be appreciated that such service bids associated with occupying the empty time slot enables the increased value to service providers associated with the service components by optimizing, for example maximizing, the utilization of the service components 120A, 130A. In one example, the service components 120A, 130A are associated with a load factor, such as, a ratio of actual utilization to optimal, for example maximum, possible utilization of the service components 120A, 130A. In such an instance, the service provider AEAs, such as service provider AEA 120, 130, can optimize, for example maximize, the load factors associated with each of the service components 120, 130.

The system 100 includes an open economic framework, implemented using a decentralized computing network 140. The term “decentralised computing network” as used herein, relates to an arrangement of a plurality of computing devices that are mutually communicably coupled with one another. In operation, each of the plurality of computing devices can perform as either a client device or a service component. Optionally, each of the plurality of computing devices can simultaneously perform as the client device and the service component. Furthermore, the decentralized computing network is optionally implemented as a decentralized structured P2P (peer-to-peer) network of devices; alternatively, multi-layer communication networks are employed, wherein communication devices are migrated between the layers depending upon their technical functionality, reliability, peer-review assessment and/or trustworthiness. Specifically, the decentralized structured P2P network represents a decentralized computing environment within a P2P network.

Moreover, the decentralized computing network includes wired and/or wireless communication arrangements (namely “communicating means”) comprising a software component, a hardware component, a network adapter component, or a combination thereof. Furthermore, the communication network may be an individual network, or a collection of individual networks, interconnected with each other and functioning as a single large network. Such individual networks may be wired, wireless, or a combination thereof. In an example, the communication network includes Bluetooth®, Internet of things (IoT), Visible Light Communication (VLC), Near Field Communication (NFC), Local Area Networks (LANs), Wide Area Networks (WANs), Metropolitan Area Networks (MANs), Wireless LANs (WLANs), Wireless WANs (WWANs), Wireless MANs (WMANs), the Internet, telecommunication networks, radio networks, and so forth.

The open economic framework 140 includes an open economic ledger, also referred to as being a “open technical ledger”) for storing a confidence score of each of the plurality of service provider AEAs, such as service provider AEA 120, 130. The term “confidence score” as used herein, relates to a likelihood of providing a successful service using a service provider AEA, such as service provider AEA 120, 130. The confidence score stored on the open economic framework 140 includes information associated with services provided using each of the plurality of service provider autonomous economic agents, such as service provider AEA 120, 130. In an embodiment, the confidence score includes at least one of historical information of services provided using the service provider autonomous economic agent, and/or a number of services provided using the service provider autonomous economic agent, technical functionality, technical capability, technical capacity. In one example, the confidence includes historical information of services provided using a service provider AEA, such as service provider AEA 120, 130. Such an historical information is associated with services provided using the service provider AEA, such as service provider AEA 120, 130 to one or more users prior to the user of the client device 110. In such an example, the historical information includes a user satisfaction rating provided by the user as a feedback subsequent to receiving the service, a success rating (such as, based on a time taken for providing the service as compared to time allotted therefor) that is automatically provided using the client AEA subsequent to completion of one or more tasks associated with the service and so forth. In another example, the confidence score includes the number of services provided using a service provider AEA, such as service provider AEA 120, 130. Such confidence score including the number of services provided using the service provider AEA enables to determine a reliability of the service provider AEA, such as service provider AEA 120, 130. For example, a service provider AEA, such as service provider AEA 120, 130 associated with a large number of services provided may be more reliable than a service provider AEA associated with a smaller number of services provided.

Furthermore, the confidence score associated with each of the plurality of service provider autonomous economic agents, such as service provider AEA 120, 130 is stored on the open technical ledger (referred to herein later open economic ledger “OEL”). The term “Open Economic Ledger” or OEL as used herein, relates to a decentralized and distributed digital ledger that records, for example, peer-to-peer digital transactions. Furthermore, the OEL is a cryptographically protected digital ledger that is capable of operating within the OEF. Optionally, the OEL is a data structure that includes a series of time-stamped blocks, wherein each block includes data corresponding to one or more transactions performed by the AEAs. Such storage of the confidence score associated with each of two or more service provider AEAs on the OEL provides the transparency of confidence score associated with services provided using each of two or more service provider AEAs. In one example embodiment, the open economic ledger is implemented using a distributed ledger, for example for protecting against a risk of hacking or a single point of technical failure within the system 100. For example, the distributed ledger employs a blockchain data structure. It will be appreciated that providing the confidence score on the distributed ledger enables to provide a relatively higher security for users of the system 100, as tampering with the distributed ledger to furnish inaccurate confidence score will be computationally expensive and therefore, unprofitable for service providers.

In an embodiment, the open economic framework 140 includes a confidence score associated with a plurality of client AEAs, stored on the OEL. For example, the confidence score associated with the plurality of client AEAs includes an historical information of services obtained using the client AEAs and/or a number of services obtained using the client AEAs, such as the client AEA 110. In such an example, a service provider AEA, such as service provider AEA 120, 130 is configured, namely operable, to analyse the confidence score associated with a client AEA prior to generating the service bid. In one example, the service bid generated for a client associated with positive confidence score (such as, high satisfaction ratings provided for services obtained from one or more service provider AEAs) is associated with a lower price and/or time required for providing the service as compared to service bid generated for a client AEA 110 associated with negative confidence score.

Furthermore, the open economic framework 140 is configured, namely operable, to select a service provider AEA for providing the service, from the plurality of service provider AEAs, such as service providers AEA 120, 130, based upon at least one of: confidence scores of the plurality of service provider autonomous economic agents, service bids provided by plurality of service provider autonomous economic agents. In an example embodiment, a service provider AEA associated with the higher confidence score will be more likely to provide a successful service as compared to a service provider AEA associated with a lower confidence score. In one example, the open economic framework 140 is operable to compare characteristics of confidence score (such as historical information of services provided, number of services provided, user satisfaction rating, service rating and so forth) associated with each of the two or more service provider AEAs associated with generation of service bids. In one example, the open economic framework 140 is operable to compare service ratings and the number of services provided using the two or more service providers AEAs. In such an instance, the open economic framework 140 is operable to determine the service provider AEA associated with an average of comparatively higher service rating and a comparatively higher number of services provided. Furthermore, the service provider AEA associated with the higher average of the service rating and the number of services provided is deemed to be associated with a higher confidence score by the open economic framework 140. It will be appreciated that such a higher confidence score is further associated with a higher likelihood of providing a successful service and subsequently, receiving a positive user satisfaction rating for the service provided as compared to another service provider AEA associated with lower confidence score.

In an example embodiment, the at least one of the service bids provided by the plurality of service provider AEAs is a collective bid provided by multiple service provider AEAs, wherein the multiple service provider AEAs collectively provide the service to the client. It will be appreciated that a certain service provider AEA may only be capable to execute a portion of the service request that is generated by the client AEA. A service request may include a plurality of steps. The term “collective bid” as used herein refers to a bid that is generated and communicated by a service provider AEA to the client AEA, wherein the service provider AEA acts on behalf of multiple service providers, and wherein the service providers collectively provide the service to the client. In such an instance, the service provider may simultaneously be a client AEA, namely a secondary client AEA, that may be acquiring services from one or more other service provider AEA, namely a second plurality of service provider AEAs for the execution of the remaining portion of the service. Therefore, the at least one of the plurality of service bids comprises a collaboration between a plurality of service provider autonomous economic agents associated with a plurality of service providers. The term “second plurality of service provider AEAs” refers to a plurality of service provider AEAs, within the OEF, that are capable of executing at least a segment/part of the remaining portion of the service.

For example, when a service provider AEA can only provide a service for a portion, namely a first portion, of the requested service, then in such a case, the service provider AEA operates as a secondary client AEA. Moreover, the secondary client AEA is configured, namely operable, to generate a secondary service request for executing a remaining portion of the service. The term “remaining portion of the service” refers to the outstanding (namely, remaining) portion of the service that remains to be executed, considering that the first portion of the service is executed by the secondary client AEA. Furthermore, the secondary client AEA is configured, namely is operable, to receive service bids from a second plurality of service provider AEAs, for executing at least a segment/part of the remaining portion of the service. In such an example, multiple service providers of the second plurality of service provider AEA may bid for providing a service for one or more segments/part of the remaining portion of the service. Furthermore, the secondary AEA is configured, namely operable, to determine one or more service providers from the second plurality of service provider autonomous economic agents to collaborate with the secondary client AEA to provide collectively the service to the client AEA.

Beneficially, such a system for managing services provides the user with an optimized management of resources, that is capable of saving energy, saving resources, saving wear-and-tear, enhancing reliability of service delivery, and so forth. The system allows for maximizing utilization of resources and maximize value for each of the parties involved, namely the client and the service providers by reducing idle time in a way that a centralized or human mediated system could not. Such a system where service provider AEAs collaborate amongst themselves to provide a collective bid for the request service allows for better utilization of resources for the service providers who are only capable of executing a segment/part of the requested service. Moreover, such a system also increases availability of options for seeking a service by the user as the system is able to take into consideration collective bids wherein multiple service provider autonomous economic agents collectively provide the service to the client. Such a system is especially effective when no single service provider is able to bid in response to the service request generated by the client AEA.

Optionally, the determination of the one or more service providers from the second plurality of service provider autonomous economic agents to collaborate with the secondary client AEA is based on the segments/parts offered for execution of the remaining portion of the service by the second plurality of service provider AEAs in the respective service bids thereby.

In one embodiment, the open economic framework 140 is operable to employ zero-knowledge protocol to compare the confidence scores associated with each of the plurality of service provider autonomous economic agents, such as service provider AEAs 120, 130. For example, the open economic framework 140 is operable to acquire services provided by one or more other service provider AEAs (such as service provider AEAs that are not associated with generation of service bids and/or client AEAs that not associated with generation of the service request) to obtain verifiable information associated with characteristics of confidence score (such as historical information of services provided, number of services provided, user satisfaction rating, service rating and so forth) for each of the plurality of service provider AEAs associated with generation of service bids. In such an example, the verifiable information associated with characteristics of confidence score is provided to the open economic framework 140 without disclosing identifiable information (for example, an identity of service providers or service components) of the one or more other service provider AEAs thereto. In one example, the service bids are generated by service provider AEAs associated with travel agencies, in response to generation of a service request for acquiring cheapest travel services between two locations. In such an instance, the open economic framework 140 is operable to acquire prices associated with past travel services provided by various service provider AEAs associated with the travel agencies (having generated service bids), wherein the past services were provided to client AEAs for travelling between the two locations. Furthermore, the open economic framework 140 is operable to employ zero-knowledge protocol to acquire such prices and to verify that the services were provided to the client AEAs by the service provider AEAs, without acquiring identifiable information associated with the client AEAs (such as, information of client device and/or personally identifiable information associated with user of the client device).

In an embodiment, the open economic framework 140 is configured, namely operable, to select the determined service provider autonomous economic agent associated with the higher confidence score for providing the service. For example, the selection of the determined service provider AEA is associated with assignment of the service request to the service provider AEA. In another embodiment, an agreement (such as a contract) is generated by the open economic framework 140, wherein the agreement includes information related to the service to be provided. For example, the agreement is a smart contract that is generated by the open economic framework 140 for the service to be provided to a given user using the client AEA, by the service provider using the selected service provider AEA. The term “smart contract” as used herein, relates to a contract that is implemented using computer protocols and is capable of performing activities such as tracking, negotiating, verifying, enforcing and fulfilling terms of a contract based on interactions between two or more AEAs. For example, the smart contract is self-negotiating, self-verifying, self-enforcing, self-fulfilling and suchlike. Optionally, the smart contract is implemented using an application programming interface (API); alternatively, the smart contracts are implemented and/or defined in digital hardware such as ASIC's, custom-designed hardware and so forth, wherein such hardware can optionally be used in a manner of transaction tokens. Additionally, the smart contract is automatically generated based on interactions between service provider AEAs and client AEAs, such as, by the OEF. For example, generation of the smart contract may include communication of one or more messages between a client AEA, a service provider AEA and the OEF. Subsequently, such agreement is shared with the client AEA and the selected service provider AEA. In one example, the agreement includes information such as a price agreed by the service provider AEA (and the client AEA) for providing the service, a time frame requested by the user for obtaining the service, one or more parameters specified by the given user (as aforementioned) and so forth. Moreover, the agreement is stored on the OEL with the confidence score associated with the service provider AEA. Subsequently, the service is provided using the service component associated with the selected service provider AEA.

In an embodiment, the selected service provider autonomous economic agent is remunerated by a digital token for the provided service. For example, the digital token (referred to herein later as the “Open Economic Token” or “OET”) is a cryptocurrency. In such an example, the cryptocurrency is used by the client AEA for remunerating the selected service provider AEA for the service provided and/or by the service provider AEA for acquiring one or more services using other service provider AEAs. It will be appreciated that such an implementation of the digital token as the cryptocurrency enables secure and digital transaction between the AEAs. In one embodiment, information associated with the remuneration is stored on the OEL. For example, transaction information associated with exchange of OETs from the client AEA to the service provider AEA is stored on the OEL along with confidence score associated with the provided service. Such storage of the transaction information on the OEL enables easier and more reliable verification of the confidence score associated with the service provider AEA, for example, based on prices imposed on the client AEA by the service provider AEA for providing the service.

In one embodiment, the digital token is stored in a digital wallet, for example in an encrypted form, or in a partially encrypted form. For example, the digital wallet is implemented as a software application that is installed on a portable communication device (such as a smartphone, a tablet computer, a laptop computer and so forth) associated with a service provider. Such digital wallet enables the service provider to receive (and withdraw) the OMTs provided to the service provider AEA associated therewith for providing services and/or to add OMTs for obtaining services using other service provider AEAs, to compensate client AEAs for failure to provide a service (such as a fine or as part of an insurance claim) and so forth.

In one example, a client AEA is associated with a travel agency that wants to ship a package from a first location to a second location. In such an instance, a service request is generated using the client AEA for obtaining the shipping services. Furthermore, the selected service provider AEA is associated with a shipping company that provides shipping services between the first location and the second location at a low price. Moreover, a second client AEA associated with an individual wants to travel from a home location to an office location thereof. In such an instance, a service request is generated using a second client AEA for obtaining the travel services. Furthermore, the selected service provider AEA is associated with the travel agency. Therefore, it will be appreciated that a client AEA (such as the AEA associated with the travel agency) can simultaneously be a service provider AEA and vice versa.

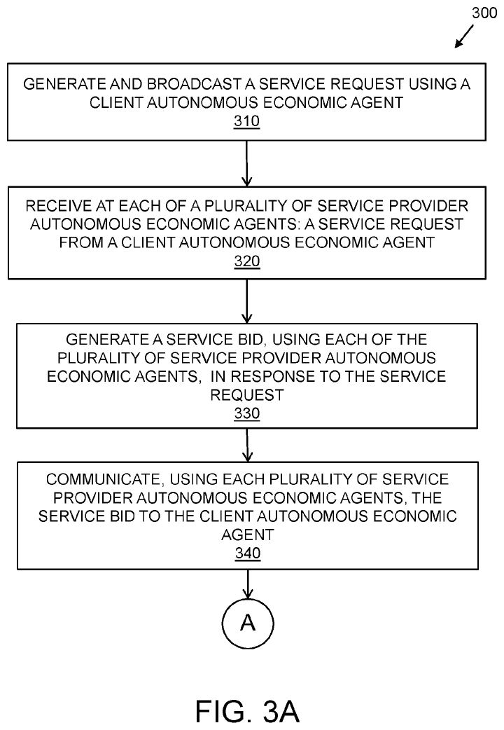

Referring to FIG. 2, there is shown a schematic illustration of the two service components 120A, 130A of FIG. 1 associated with a drone 200, in accordance with an embodiment of the present disclosure. In one embodiment, the service components include at least one of a drone frame 210, a camera module 220, a mission planning module 230, a sensor module 240, and/or a communication module 250. In one example, the service request includes a request to perform aerial photography associated with a location, such as, for aerial inspection. Furthermore, the service request includes one or more parameters, such as a price associated with the service, a time associated with the service, and so forth. In such an example, the selected service provider AEA is the service provider AEA associated with the camera module 250. However, the service provider AEA associated with the camera module 250 will be required to negotiate with a service provider AEA associated with the drone frame 210 for carrying the camera module 250 to the location. Furthermore, the service provider AEA associated with the drone frame 210 will be required to negotiate with a service provider AEA associated with the mission planning module 230 for generating a flight plan for journey of the drone 200 from a current location thereof to the location. Moreover, the service provider AEA associated with the mission planning module 230 will be required to negotiate with a service provider AEA associated with an insurance provider (external to the drone 200, not shown) to obtain an insurance for the flight. In such an example, the service provider AEAs associated with various service components of the drone 200 are configured, namely operable, to generate respective service requests and accept service bids generated by the respective service provider AEAs.

In an embodiment, each of the client autonomous economic agents and the service provider autonomous economic agents is connected to a data processing arrangement. In one example, the client AEA is connected to a data processing arrangement provided on a portable communication device associated with the user. In another example, the each of the service provider AEAs are connected to individual data processing arrangements that are further coupled to the service components 210 to 250. In such an example, providing the service provider AEAs on the respective data processing arrangements enables communication of the various service provider AEAs for collaboration therebetween, for generation of the service bid.

In one embodiment, a service provider AEA is configured, namely operable, to allow revision of one or more characteristics associated with the generated service request. In one example, the service provider AEA associated with the sensor module 240 is the selected service provider AEA for a second service request, such as, a service request associated with surveying a location adjacent to the location of aerial inspection by the camera module 250. In such an instance, the sensor module 240 negotiates with the service provider AEA associated with the mission planning module 230 for revising the flight plan. In such an example, a portion of remuneration for providing the service by the sensor module 240 is provided to the mission planning module 230 and the camera module 250 respectively. In such an example, as a higher value is provided for the mission planning module 230 (associated with an increase in remuneration), the camera module 250 (associated with an increase in remuneration) and the sensor module 240 (that may be required to compensate only for deviation from an original flight plan associated with the aerial inspection), the revision is accommodated into the flight plan. Optionally, the revision is accommodated into the flight plan only if the revised flight plan complies with one or more parameters (such as a price associated with the service, a time associated with the service and so forth) provided with the service request.

According to one embodiment, at least one of the plurality of service bids comprises a collaboration between a plurality of service provider autonomous economic agents associated with a plurality of service providers. In one example, the drone frame 210, the camera module 220, the mission planning module 230, the sensor module 240, and/or the communication module 250 may be associated with different service providers respectively. In such an example, for generating the service bid for performing aerial inspection of a location, the service provider AEAs associated with the drone frame 210, the camera module 220, and the mission planning module 230 may collaborate with each other to generate the service bid. It will be appreciated that in such an example, the at least two service components, such as, the camera module 220, the mission planning module 230, the sensor module 240 and the communication module 250 are physically associated with the drone frame 210 (and may be further electrically connected to each other).

However, the service components may potentially not be physically associated with each other. For example, the service components include a taxi, a bus and a ferry. Furthermore, each of the taxi, the bus and the ferry are associated with a service provider AEA. Moreover, when a service request generated by a user is associated with travelling from a first location to a second location that may require use of the taxi, the bus and the ferry, the service is provided using the service provider AEAs associated with each of the taxi, the bus and the ferry. In such an instance, the service provider AEAs associated with the taxi, the bus and the ferry are configured, namely operable, to collaborate to generate a single service bid to enable the user's journey from the first location to the second location.

According to an embodiment, OETs are provided to a service provider AEA prior to providing the service associated with the generated service request. For example, the client AEA provides OETs to one or more service provider AEAs for locating a service provider AEA capable of providing a service required by a user (such as, based on a preference of the user). In another example, the client AEA provides OETs to a service provider AEA for allowing access to use one or more service provider AEAs. In yet another example, the client AEA provides OETs to one or more service provider AEAs associated with premium capabilities, including, but not limited to, service provider AEAs capable of providing faster services, service provider AEAs capable of providing eco-friendly services, service provider AEAs associated with high service ratings, and so forth. In yet another example, a service provider AEA provides OETs to a client AEA for allowing revision of service request generated by the client AEA.

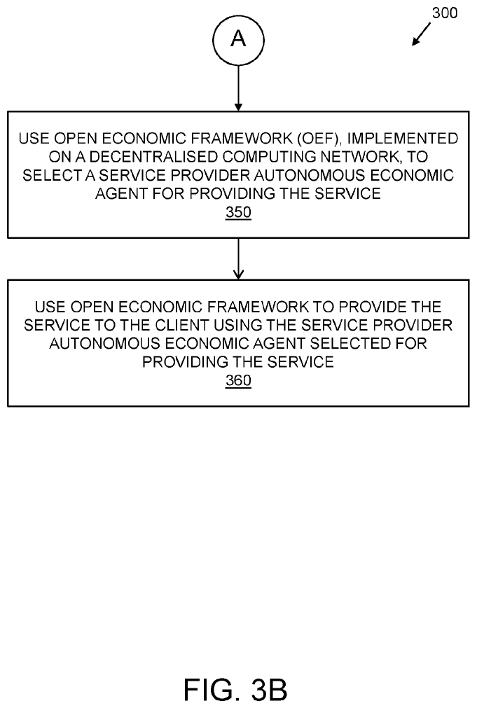

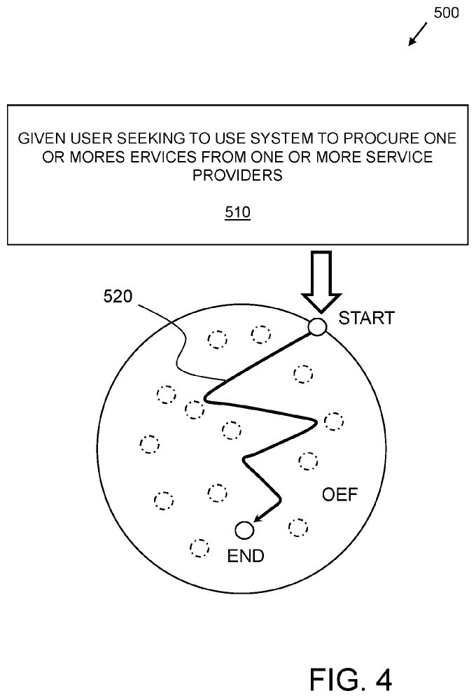

Referring to FIG. 3, there are illustrated steps of a method 300 for (of) using one or more autonomous economic agents to provide a service, for example a technical service, in accordance with an embodiment of the present disclosure. At a step 310, a service request is generated and broadcasted using a client autonomous economic agent. At a step 320, the service request from the client autonomous economic agent is received by each of the plurality of service provider provider autonomous economic agents. At a step 330, a service bid is generated, in response to the service request, by each of the plurality of service provider autonomous economic agents. At a step 340, the service bid is communicated to the client autonomous economic agent by each of the plurality of service provider autonomous economic agents. At a step 350, a service provider autonomous economic agent is selected for providing the service, based upon at least one of: confidence scores of the plurality of service provider autonomous economic agents, service bids provided by plurality of service provider autonomous economic agents. At a step 360, service is provided to the client using the selected service provider autonomous economic agent. In FIG. 4, a graphical representation of the method is provided in addition to the steps of the method illustrated in FIG. 3A and FIG. 3B.

The steps 310 to 360 are only illustrative and other alternatives can also be provided where one or more steps are added, one or more steps are removed, or one or more steps are provided in a different sequence without departing from the scope of the claims herein. In an example, the service request includes one or more parameters, for example a time needed for providing the service, a price associated with the service, a quality associated with the service, and/or at least one preference associated with the service. In another example, each of the client autonomous economic agents and the service provider autonomous economic agents is connected to a data processing arrangement. In yet another example, the selected service provider autonomous economic agent is remunerated by a digital token (i.e. OETs) for the provided service. In one example, information associated with the remuneration is stored on the OEL. In another example, the digital token is stored in a digital wallet. In yet another example, at least one of the two or more service bids comprises a collaboration between a plurality of service provider autonomous economic agents associated with a plurality of service providers.

The method and system of the present disclosure enables the service request using the client AEA to be generated. The service request generated using the client AEA enables the definition of the requirements associated with the provided service. It will be appreciated that providing such service request enables the user to identify service providers that are capable of providing the service as per the requirements, thereby, reducing the user's effort for identifying capable service providers. Furthermore, a plurality of service bids is generated in response to the generated service request. Such service bids generated in response to the service request ensures that the service providers are capable of providing the service as required by the user, thereby saving time and money for the user and enabling the service providers to provide services as per their capabilities. Moreover, generation of the plurality of service bids provides the user with different options with respect to the service providers that are capable of providing the service. Furthermore, each of service provider AEAs are associated with confidence score, wherein the confidence score is stored on the OEL. It will be appreciated that providing such confidence score endorses ability of the service providers to deliver the service (such as, via the service components), thereby further saving time and money for the user. Moreover, providing the confidence score on the OEL provides transparency of information associated with services provided by the service provider. Furthermore, the confidence score associated with the service provider AEAs is compared to determine the higher confidence score. Such determination of the higher confidence score ensures reliability of the service provider AEA and further, increases the likelihood of obtaining successful service by the service provider. The service provider AEA is selected for providing the service, based upon at least one of: confidence scores of the plurality of service provider autonomous economic agents, service bids provided by plurality of service provider autonomous economic agents. Such selection of the service provider AEA ensures that the service provider that is capable of successfully providing the highest quality of service to the user, according to the user's requirements, is chosen for providing the service. It will be appreciated that the method and system of the present disclosure saves time and money for the user by providing highly reliable and successful services using the one or more autonomous economic agents.

Optionally, at least one of the service bids provided by the plurality of service provider autonomous economic agents is a collective bid provided by multiple service provider autonomous economic agents, wherein the multiple service provider autonomous economic agents collectively provide the service to the client.

Optionally, one of the multiple service provider autonomous economic agents operates as a secondary client autonomous economic agent, wherein the secondary client autonomous economic agent is operable to execute a first portion of the service, and wherein the method includes:
generating a secondary service request for executing a remaining portion of the service;
receiving service bids from a second plurality of service provider autonomous economic agents, for executing at least a segment/part of the remaining portion of the service;
determining, from the second plurality of service provider autonomous economic agents, one or more service provider autonomous economic agents to collaborate with the secondary client autonomous economic agent to form multiple service provider autonomous economic agents collectively providing the service.

Optionally, the confidence score includes at least one of:
historical information of services provided using the service provider autonomous economic agent;
number of services provided using the service provider autonomous economic agent.

Optionally, the service request includes at least one of: a time needed for providing the service; a price associated with the service; a quality associated with the service; at least one preference associated with the service.

Optionally, each of the client autonomous economic agent and the service provider autonomous economic agents is connected to a data processing arrangement.

Optionally, the selected service provider autonomous economic agent is remunerated by a digital token for the provided service.

Optionally, the open economic ledger is implemented using a distributed ledger.

Optionally, the open economic ledger is a data structure that includes a series of time-stamped blocks, wherein each block includes data corresponding to one or more transactions performed by the autonomous economic agents.

Optionally, when implementing the degree of data protection, the decentralized computing network encrypts one or more transaction events by employing intelligent algorithms to secure the open economic framework (OEF), wherein the intelligent algorithms include adaptive data encryption and data obfuscation processing operations. By enhancing the degree of data protection, the decentralized computing network is less prone to being disrupted by malicious third parties, for example by injection of computer viruses or by selective eavesdropping and substitution of data flows within the decentralized computing network. By employing data protection within the decentralized computing network that is adaptively adjusted depending upon one or more parameters of transactions implemented within the system, the system can be both highly efficient in its operation and also highly robust to attack.

More optionally, when the decentralized computing network is in operation, the adaptive data encryption and data obfuscation processing operations are selected depending upon at least one of:
(i) a temporal rate of execution of transactions via a given node of the decentralized computing network,
(ii) considerations associated with transactions being executed via a given node of the decentralized computing network.

More optionally, the adaptive data encryption and data obfuscation processing operations employ a combination of following data protection processes:
(i) data encryption, for example using a private-public key encryption regime;
(ii) data decryption, for example using a private-public key encryption regime;
(iii) data obfuscation by swapping one or more bits of data bytes, wherein such swapping is performed pursuant to a swapping template that is communicated within the decentralized computing network in an encrypted manner;
(iv) an addition of obfuscating redundant data (namely, “data decoys”), for example, added as “padding” to data being communicated within the decentralized computing network; and
(v) temporally randomized transmission times for data within the decentralized computing network.

It will be appreciated that combinations of obfuscation, for example swapping of nibbles of bytes, and encryption (likewise, corresponding de-obfuscation and decryption) are capable of approaching a “one time pad” degree of data protection which can only be attacked by using extreme amounts of data processing resources that would not normally be available to malicious third parties.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A method of employing a plurality of software agents to perform a service, comprising the steps of:
receiving a user service requirement from a client device;
sending the user service requirement to a client agent associated with a computing framework, wherein the computing framework comprises the client agent, a plurality of service agents, and a list of capabilities of the plurality of service agents;
transmitting, by the client agent, the user service requirement to an artificial intelligence system;
generating, by the artificial intelligence system, a service request, wherein the artificial intelligence system autonomously generates the service request, and wherein the service request comprises a first set of tasks;
receiving, by the client agent, the service request;
transmitting, by the client agent, the service request to a node of the computing framework; and
selecting, by the node, a service agent of the plurality of service agents to perform a task of the first set of tasks, wherein the selection is based on the service request and the list of capabilities.

2. The method of claim 1, wherein the artificial intelligence system employs self-adjusting, adaptive machine learning models.

3. The method of claim 2, wherein the node transmits an agreement to the selected service agent, wherein the agreement comprises a data structure that conforms to a requirement of an application programming interface, and the agreement comprises one or more parameters associated with the first task.

4. The method of claim 2, wherein the selected service agent receives an agreement from the node, the agreement comprising a data structure that conforms to a requirement of an application programming interface and the agreement comprises one or more parameters.

5. The method of claim 1, wherein the selected service agent executes the first task of the first set of tasks, and wherein the execution includes performing an action autonomously using a machine.

6. The method of claim 2 further comprising, where the service request comprises a second set of tasks;
receiving, by the client agent, the second set of tasks;
transmitting, by the client agent, the second set of tasks to a second node of the computing framework; and
selecting, by the second node, a second service agent of the plurality of service agents to perform a task of the second set of tasks, wherein the selection is based on the second set of tasks and the list of capabilities.

7. The method of claim 2, wherein the computing framework further comprises a ledger, wherein the ledger stores a record of interactions between the client agent and the service agent, and wherein the record comprises at least one of historical information of services, technical functionality, technical capability, and technical capacity.

8. The method of claim 2, wherein the node selects the service agent based on a comparison of the service request and the list of capabilities.

9. The method of claim 2, wherein the node selects the service agent based on a highest confidence score, wherein the confidence score comprises at least one of historical information of services, number of services provided, user satisfaction, technical capability, technical functionality, technical capacity.

10. The method of claim 2, wherein the client agent is the service agent.

11. The method of claim 2, wherein the list of capabilities comprises at least one of historical information of services provided, number of services provided, technical functionality, technical capability, and technical capacity.

12. The method of claim 2, wherein the node generates an agreement between the client agent and service agent based on interactions between the client agent and the service agent.

13. The method of claim 2, wherein the node selects the service agent using the artificial intelligence system, and wherein the artificial intelligence system selects the service agent based on the service request and the list of capabilities.

14. The method of claim 2, wherein the service request further comprises at least one of the user service requirement, a data structure that conforms to a requirement of an application programming interface, and computer readable code.

15. The method of claim 2, wherein a service provider associated with the service agent executes the service on a computer processor.

16. A system for employing a plurality of software agents to perform a service, the system comprising:
a computing framework comprising one or more processors, a client agent, a plurality of service agents, a node, and a list of capabilities of the plurality of service agents;
wherein the computing framework is configured to receive a user service requirement from a client device;
wherein the client agent is associated with the computing framework and is configured to:
receive the user service requirement;
transmit the user service requirement to an artificial intelligence system, wherein the artificial intelligence system is configured to autonomously generate a service request based on the user service requirement, the service request comprising a first set of tasks; and
receive the service request from the artificial intelligence system and provide the service request to the node of the computing framework; and
wherein the node is configured to select a service agent of the plurality of service agents to perform a task of the first set of tasks based on the service request and the list of capabilities.

17. The system of claim 16, wherein the artificial intelligence system is configured to employ self-adjusting, adaptive machine learning models.

18. The system of claim 16, wherein data communications of the computing framework are protected by adaptively employing at least one of data encryption or data obfuscation.

19. The system of claim 16, wherein the computing framework further comprises a distributed ledger configured to store a record of interactions between the client agent and the selected service agent, wherein the record is stored in one or more time-stamped blocks.

20. A non-transitory computer-readable medium storing computer-readable instructions that, when executed by one or more processors of a computing framework, cause the computing framework to perform the method of claim 1.
